(19) United States
(12) Patent Application Publication
(10) Pub. No.: US 2024/0119490 A1
(43) Pub. Date: Apr. 11, 2024

(54) SYSTEM AND METHOD FOR RECOMMENDING PROGRAMS BASED ON INTEREST OF THE USERS

(71) Applicant: SCHOOL WIZARD PRIVATE LIMITED, Ernakulam (IN)

(72) Inventor: Dilip RAMACHANDRAN, Kollam (IN)

(21) Appl. No.: 17/962,508

(22) Filed: Oct. 9, 2022

(51) Int. Cl. G06Q 30/02; G06Q 50/20

(52) U.S. Cl. CPC G06Q 30/0282; G06Q 30/0203; G06Q 50/20

(57) ABSTRACT

The present disclosure relates to a system (100) for recommending programs options to a plurality of users, the system comprising a processor (112) operatively coupled to a memory (114), the memory storing instructions executable by the processor (112) to receive a set of identity attributes of a plurality of users (108) associated with a computing device (106). The processor can generate a set of questionnaires to be filled by the plurality of users to capture a set of attributes of the plurality of users associated with each question. The processor can perform interactive feedback and can generates an assessment score for the respective set of attributes of the plurality of users and recommends a set of program IDs corresponding to each assessment score of the plurality of users to facilitate the learning ability of the plurality of users.

### TECHNICAL FIELD

The present disclosure relates, in general, to the educational system, and more specifically, relates to a system and method for generating assessment scores and recommending programs/products based on the interest of the users.

### BACKGROUND

There is a growing appreciation that economic development is closely tied to the quality of education and therefore there is a desire of businesses and government institutions to significantly increase access to quality education, often in very specific areas tied to economic opportunities. Interactive learning technologies have played a role in improving accessibility by placing course materials online for consumption using Internet media and Internet communication. Learning management systems have appeared to enable such E-learning that improves student engagement with educational content.

Few existing E-learning platforms have several limitations that are as follows:
Skills overlooked—A student's inborn skills are often overlooked most of the time unless it's aligned with the academic curriculum they pursue.
Lack of student's skill nurturing platform—No effective single system that will guide parents to identify their kid's unique skills, nurture them and map them to a suitable career. No platform that maps quality programs based on the uniqueness and interests of a child.
Traditional methods for nurturing students—For a fair selection, every child is assessed with their reading, writing and arithmetic skills. Parents and teachers use traditional methods or trends to understand children and tend to have a generalized approach to guiding them.

Further, in the existing system, traditional collaborative filtering recommendations can address in-matrix prediction, items that have been rated by at least one user in the system. Such a recommender system cannot handle out-of-matrix prediction, where items have never been rated by users in the system. Moreover, all types of uncertainty in data while responding to a questionnaire cannot be handled.

Therefore, it is desired to overcome the drawbacks, shortcomings, and limitations associated with existing solutions, and develop an efficient system that identifies interest areas of students and recommends the best programs to the students based on their interests and assessment results.

### OBJECTS OF THE PRESENT DISCLOSURE

An object of the present disclosure relates, to the educational system, and more specifically, relates to a system and method for generating assessment scores and recommending programs/products based on the interest of the users.

Another object of the present disclosure is to provide a system that identifies interest areas of students and recommends the best programs to the students based on their interests and assessment results.

Another object of the present disclosure is to provide a system that provides collaborative topic regression (CTR) approach to the recommendation engine by recommending items to a user not only based on an in-matrix prediction but also out-of-matrix prediction.

Another object of the present disclosure is to provide a system that distinguishes the user features for explaining recommendations from features important for explaining user behaviour.

Another object of the present disclosure is to provide a system using a CTR model that may recommend the appropriate program IDs giving an accuracy of 95-97% by analysing the new user's features and previous user's features.

Another object of the present disclosure is to provide a system with a CTR model that is very robust in recommending the appropriate programs for the user, the CTR model has the capabilities to build the trusted user by taking the social matrix factorization.

Another object of the present disclosure is to provide a system that handles uncertainty by using an expert engine and easily mapping questions to assessments with high accuracy.

Another object of the present disclosure is to provide a system that helps to transfer human intelligence to machine intelligence, thereby producing results in a very appropriate way.

Another object of the present disclosure is to provide a system that appropriately converts qualitative input data such as questionnaires, age, demographic data, and social data to quantitative output data such as assessment along with a probability score.

Yet another object of the present disclosure is to provide a system that takes lower computational cost i.e., less than 3 seconds.

### SUMMARY

The present disclosure relates to an educational system, and more specifically, relates to a system and method for generating assessment scores and recommending programs based on the interest of the users. The main objective of the present disclosure is to overcome the drawback, limitations, and shortcomings of the existing system and solution, by providing a system that identifies the interest areas of students and recommends the best programs to the students based on their interests and assessment results. The interests of the students are captured by conducting an online questionnaire survey using multi-item likert scales, which are filled by their parents. Based on the input data, a suitable assessment is recommended e.g., two or three suitable assessment is recommended based on the interest of the student, after which an assessment score based on the level of the assessment is generated for the respective interests and skills of the students. Accordingly, the system can recommend the set of program IDs corresponding to each assessment score. By using a recommendation system, suitable programs with the best ratings are recommended to the parents. The parents are also given a chance to rate the program, which they are attending. Using this application, the fundamental interest of the ward can be improvised and the learning can be made very fascinating to the kids as well as to the parents.

The present disclosure provides a processor operatively coupled to a memory, the memory storing instructions executable by the processor to receive a set of identity attributes of a plurality of users. The set of identity attributes pertains to the age of the plurality of users, occupation of the parent, education of the parent and any combination thereof. The processor can generate a set of questionnaires to be filled by the plurality of users to capture a set of attributes of the plurality of users associated with each question in the set of questionnaires. The set of attributes pertaining to the interest and skill of the plurality of users. The set of attributes associated with the set of questionnaires is identified by setting a score that is greater than or equal to a defined threshold.

Further, the processor can perform interactive feedback for the plurality of users based on the set of attributes and generate an assessment score for the respective set of attributes of the plurality of users based on the feedback response from the plurality of users. The processor can recommend a set of program IDs corresponding to each assessment score of the plurality of users. The set of program IDs is recommended based on the assessment scores, the set of attributes and the history of ratings of programs to facilitate the learning ability of the plurality of users.

Moreover, the processor is coupled to the learning engine adapted to capture the set of attributes of the plurality of the users to generate corresponding assessment scores. The learning engine is trained to recommend the set of program IDs corresponding to each assessment score of the plurality of users to nurture the interest of the plurality of users. The learning engine can include a recommendation engine and an expert engine. The expert engine minimizes the uncertainty in obtaining the appropriate assessment scores by using the received set of attributes along with the set of identity attributes of the plurality of users. The system handles uncertainty by using the expert engine and easily mapping questions to assessments with high accuracy. The expert engine helps to transfer human intelligence to machine intelligence, thereby producing results in a very appropriate way. The expert engine appropriately converts qualitative input data such as questionnaire, age, demographic data, and social data to quantitative output data assessment along with a probability score and takes lower computational cost i.e., less than 3 seconds. In addition, the processor adds products or services by a seller, in which programs are mapped based on age group, skill, and category of skill score.

Accordingly, the recommendation engine recommends the set of program IDs corresponding to each assessment score, and the assessment scores for the plurality of users are utilised to evaluate the aptitude of each user. The recommendation of the set of program IDs is determined based on the criteria value to select any or a combination of collaborative topic regression (CTR) mode or random selection mode. The CTR approach recommends items to a user based on an in-matrix prediction but also out-of-matrix prediction. The CTR distinguishes the user features for explaining recommendations from features important for explaining user behaviour. The CTR model may recommend the appropriate program IDs giving an accuracy of 95-97% by analysing the new user's features and previous user's features. The CTR model is very robust in recommending the appropriate programs for the user and the CTR model has the capabilities to build the trusted user by taking the social matrix factorization.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1A illustrates an exemplary network implementation of an AI system in accordance with an embodiment of the present disclosure.

FIG. 1B illustrates an exemplary functional component of a system, in accordance with an embodiment of the present disclosure.

FIG. 2A illustrates a framework for the application in accordance with an embodiment of the present disclosure.

FIG. 2B illustrates an exemplary representation of the AI system flow framework in accordance with an embodiment of the present disclosure.

FIG. 2C illustrates an exemplary flow chart of the expert system in accordance with an embodiment of the present disclosure.

FIG. 3A illustrates an exemplary representation of the fuzzy expert system in accordance with an embodiment of the present disclosure.

FIG. 3B illustrates an exemplary representation of the expert system algorithm in accordance with an embodiment of the present disclosure.

FIG. 4 illustrates an exemplary flow chart of program recommendations using random selection in accordance with an embodiment of the present disclosure.

FIG. 5A illustrates an exemplary flow chart of representation of program recommendations using the collaborative topic regression (CTR) model in accordance with an embodiment of the present disclosure.

FIG. 5B illustrates an exemplary CTR model in accordance with an embodiment of the present disclosure.

FIG. 6 illustrates an exemplary flow chart of a method for recommending program options to a plurality of users, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, to the educational system, and more specifically, relates to a system and method for generating assessment scores and recommending programs/products based on the interest of the users. The proposed system disclosed in the present disclosure overcomes the drawbacks, shortcomings, and limitations associated with the conventional system providing an artificial intelligence (AI) system that captures, enriches, and nourishes users e.g., student interests and talents, thereby channelizing opportunities for them to thrive in their career with the support and guidance of parents, teachers, and schools. The system is a network orchestrated platform mounted with a scientifically-driven technique that analyses and enhances the inbred capabilities of the younger generation.

The advantages achieved by the system of the present disclosure can be clear from the embodiments provided herein. The system identifies interest areas of students and recommends the best programs to the students based on their interests and assessment results. The system provides collaborative topic regression (CTR) approach to recommendation systems by recommending items to a user not only based on an in-matrix prediction but also out-of-matrix prediction. The CTR model may recommend the appropriate program IDs giving an accuracy of 95-97% by analysing the new user's features and previous user's features. The CTR model is robust in recommending the appropriate programs for the user, the CTR model has the capabilities to build the trusted user by taking the social matrix factorization.

The system handles uncertainty by using an expert system and easily mapping questions to assessments with high accuracy. The system helps to transfer human intelligence to machine intelligence, thereby producing results in a very appropriate way. The system appropriately converts qualitative input data such as questionnaires, age, demographic data, and social data to quantitative output data assessment along with a probability score. Further, the system takes lower computational cost i.e., less than 3 seconds. The description of terms and features related to the present disclosure shall be clear from the embodiments that are illustrated and described; however, the invention is not limited to these embodiments only. Numerous modifications, changes, variations, substitutions, and equivalents of the embodiments are possible within the scope of the present disclosure. Additionally, the invention can include other embodiments that are within the scope of the claims but are not described in detail with respect to the following description.

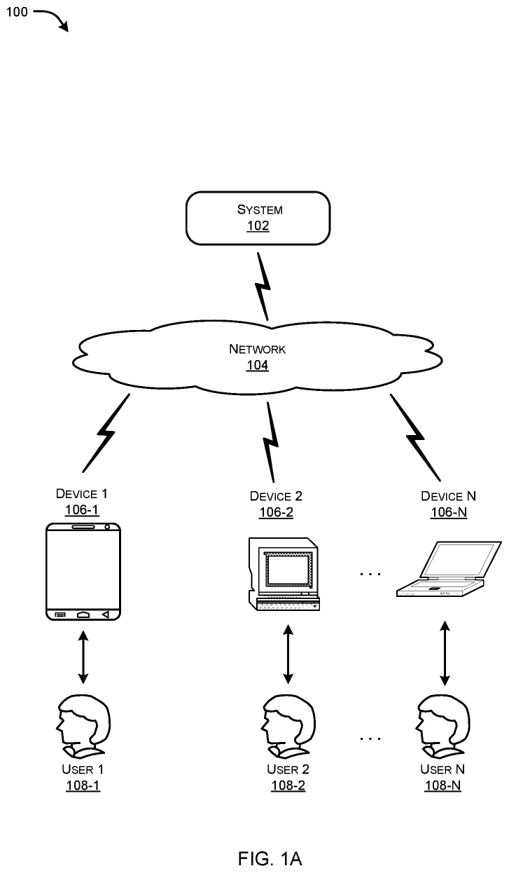

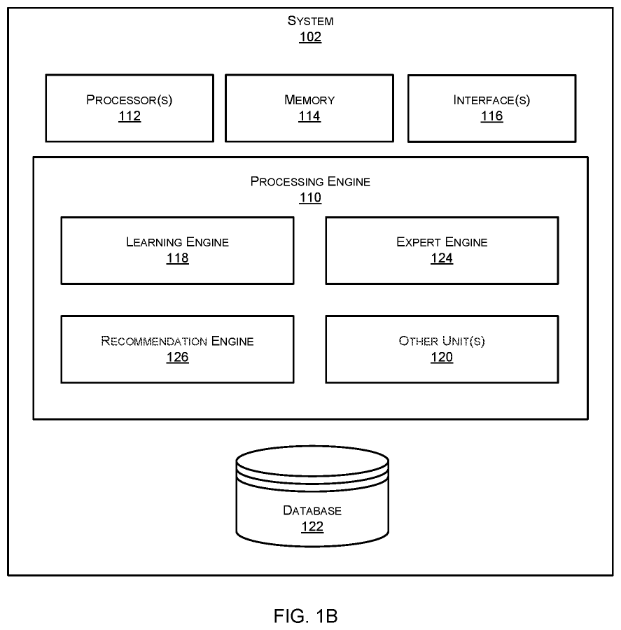

FIG. 1A illustrates an exemplary network implementation of an artificial intelligence (AI) system in accordance with an embodiment of the present disclosure.

According to network implementation 100, an artificial intelligence (AI) system 102 (also referred to as a system, 102 herein) can facilitate managing the age group, skill, and category of skill score of students. Although the present subject matter is explained considering that system 102 is implemented as an application on a server, it may be understood that system 102 may also be implemented in a variety of computing systems, such as a laptop computer, desktop computer, notebook, a workstation, a server, a network server, a cloud-based environment, and the like. It would be appreciated that the system 102 may be accessed by multiple users 108-1, 108-2 . . . 108-N (collectively referred to as users 108, and individually referred to as the user108, hereinafter)), through one or more computing devices 106-1, 106-2 . . . 106-N (collectively referred to as computing devices 106 and individually referred to as computing device 106, hereinafter)), or applications residing on the computing devices 106. In an embodiment, the user 108 can be the parents or students that manage their interests using the application to provide information about themselves. Users 108 create their profiles and the profiles are maintained and managed by system 102 and are accessible by appropriate corresponding authorities. In another embodiment, the users 108 can be sellers that can sell additional products or services to the system 102.

In one implementation, network 104 can be a wireless network, a wired network, or a combination thereof. Network 104 can be implemented as one of the different types of networks, such as an intranet, local area network (LAN), wide area network (WAN), the internet, and the like. Further, network 104 may either be a dedicated network or a shared network. In another implementation network 104 can be a cellular network or mobile communication network based on various technologies, including but not limited to, Global System for Mobile (GSM), General Packet Radio Service (GPRS), Code Division Multiple Access (CDMA), Long Term Evolution (LTE), WiMAX, and the like.

In an implementation, user 108 can access system 102 through an application residing on the computing device 106. User 108 can self-register himself with system 102 using information also interchangeably referred to as identity attributes, where the identity attributes include name, age, gender, educational qualification, mobile number, address, services, and other related information.

In an embodiment, system 102 is configured for recommending program options to the users. The system can include the processor 112 operatively coupled to the memory 114 shown in FIG. 1B. The memory 114 stores instructions executable by the processor 112 to receive a set of identity attributes of the users 108 associated with the computing device 106. The set of identity attributes pertains to the age of the users, occupation of a parent, education of the parent and any combination thereof, wherein the users are students.

The processor 112 can generate a set of questionnaires to be filled by the users 108 to capture a set of attributes associated with each question in the set of questionnaires. The set of attributes pertaining to the interest and skill of the users 108. The set of attributes associated with the set of questionnaires is identified by setting a score that is greater than or equal to a defined threshold.

The processor 112 can perform interactive feedback for the users 108 based on the set of attributes. The two or more suitable assessments is provided to the users 108 based on the filled input data, a set of categories of the users 108 are determined based on the two or more assessments, the set of categories pertaining to novice, developing and proficient. The processor 112 can generate an assessment score for the respective set of attributes of the users 108 based on the feedback response from the users 108. The processor 112 can recommend the set of program IDs corresponding to each assessment score e.g., interest score of users 108. The set of program IDs is recommended based on the assessment scores, the set of attributes and the history of ratings of programs to facilitate the learning ability of the users 108.

In an exemplary embodiment, the processor 112 is operatively coupled to a learning engine 118, the learning engine 118 is adapted to capture the set of attributes of the users 108 to generate corresponding assessment scores. The learning engine 118 is trained to recommend the set of program IDs corresponding to each assessment score of the users 108 to nurture the interest of the users 108. The learning engine 118 can include an expert engine 124 and recommendation engine 126.

The expert engine 124 minimizes the uncertainty in obtaining the appropriate assessment scores by using the set of attributes along with the set of identity attributes of the users 108. For example, while responding to a questionnaire, at times parents are confused about their answers, when their kid's age varies like 6.1, 6.2, 6.5, or close to 7 years an ambiguity prevails whether the user needs to consider 6.1-6.5 years to 6 years or 7 years. If they consider 6.1-6.5 to 7 years then the result may be biased. This type of uncertainty is handled here by using an expert engine and easily mapping questions to assessments with high accuracy (>97%). The expert engine 124 developed using fuzzy inference engines helps to transfer human intelligence to machine intelligence. Therefore, the expert engine produces results in a very appropriate way. Further, the expert engine appropriately converts qualitative input data e.g., questionnaire, age, demographic data, and social data to quantitative output data e.g., assessment along with a probability score. The entire process takes a lower computational cost less than 3 seconds. Thus, in this application, the proposed expert engine is a very robust system.

The recommendation engine 126 recommends a set of program IDs corresponding to each assessment score. The assessment scores for user 108 are utilised to evaluate the aptitude of each user. The recommendation engine 126 determines the recommendation of the set of program IDs based on the criteria value to select any or a combination of collaborative topic regression (CTR) mode or random selection mode. The CTR approach of the recommendation engine 126 has an advantage over the traditional systems by recommending items to a user not only based on an in-matrix prediction but also on out-of-matrix prediction. The CTR approach has the benefits of considering user features apart from the user ratings in the recommendation. Thus, distinguishing the user features for explaining recommendations from features important for explaining user behaviour. The proposed CTR model has the capabilities to build the trust of the user by taking the social matrix factorization. Once the trust relationship is built, the system may behave based on the feedback of the user. Therefore, the principle and mechanism of the CTR model are very robust in recommending the appropriate programs for the user. Further, the recommendation engine using the CTR model can recommend the appropriate program IDs giving an accuracy of 95-97% by analysing the new user's features and previous users' features.

For example, an interest survey consists of around 48 questions on a 5-point Likert scale to identify various interests of the students. Parents are responsible for exploring, honing, and helping children develop their potential talents. For this reason, it is important to carry out an interest survey from an early age so that the potential for children's talents can be developed optimally. The interests and talents of each child can vary, including academics, sports, arts, leadership, technology and so on. The survey questions are categorized into ten main interests and their subsets to capture a broad range. The main aim of this survey is to identify what their passionate about as it is important to their overall contentment level.

For example, the basic life skill assessment consists of ten main life skills and their sub-skills. One of the main skills is perseverance. The sub-skills for this skill include focus, commitment, concentration, and completion of the task. The skills and interest of the students are assessed through questionnaires which includes questions/activities/gamification/virtual reality-augmented reality experiences related to the skill, interest, and different options from which the participant must choose an option that he/she feels is appropriate. Based on the answers given by the students, scoring is performed. Once the assessment is done, one would get a clear understanding of which category the child or student falls in based on the assessment score, which includes novice, developing and proficient. After a complete assessment inferences, interpretations of the scores and recommendations to improve the skills are also provided to the students. Thus, through the assessment, one could enhance those skills they lack and utilize those skills to achieve their goals.

Further, the processor 112 adds products or services by a seller, in which programs are mapped based on age group, skill, and category of skill score. Thus, the present disclosure overcomes the drawbacks, shortcomings, and limitations associated with existing solutions, and provides an effective system that identifies interest areas of students and recommends the best programs to the students based on their interests and assessment results.

FIG. 1B illustrates an exemplary functional component of a system, in accordance with an embodiment of the present disclosure. In an aspect, system 102 may comprise one or more processor(s) 112. The one or more processor(s) 112 may be implemented as one or more microprocessors, microcomputers, microcontrollers, digital signal processors, central processing units, logic circuitries, and/or any devices that manipulate data based on operational instructions. Among other capabilities, the one or more processor(s) 112 are configured to fetch and execute computer-readable instructions stored in a memory 114 of the system 102. The memory 114 may store one or more computer-readable instructions or routines, which may be fetched and executed to create or share the data units over a network service. The memory 114 may comprise any non-transitory storage device including, for example, volatile memory such as RAM, or non-volatile memory such as EPROM, flash memory, and the like.

System 102 may also comprise an interface(s) 116. The interface(s) 116 may comprise a variety of interfaces, for example, interfaces for data input and output devices, referred to as I/O devices, storage devices, and the like. The interface(s) 116 may facilitate communication of system 102. The interface(s) 116 may also provide a communication pathway for one or more components of the system 102. Examples of such components include, but are not limited to, processing engine(s) 110 and database 122.

The processing engine(s) 110 may be implemented as a combination of hardware and programming (for example, programmable instructions) to implement one or more functionalities of the processing engine(s) 110. In the examples described herein, such combinations of hardware and programming may be implemented in several different ways. For example, the programming for the processing engine(s) 110 may be processor-executable instructions stored on a non-transitory machine-readable storage medium and the hardware for the processing engine(s) 110 may comprise a processing resource (for example, one or more processors), to execute such instructions. In the present examples, the machine-readable storage medium may store instructions that, when executed by the processing resource, implement the processing engine(s) 110. In such examples, system 102 may comprise the machine-readable storage medium storing the instructions and the processing resource to execute the instructions, or the machine-readable storage medium may be separate but accessible to system 102 and the processing resource. In other examples, the processing engine(s) 110 may be implemented by electronic circuitry.

The database 122 may comprise data that is either stored or generated as a result of functionalities implemented by any of the components of the processing engine(s) 110 or the system 102. In an exemplary embodiment, the processing engine(s) 110 may include a learning engine 118, expert engine 124, the recommendation engine 126 and other engine(s) 120 can supplement the functionalities of the processing engine 110 or the system 102. In an embodiment, the learning engine 118 is trained to recommend a set of program IDs corresponding to each assessment score of the user.

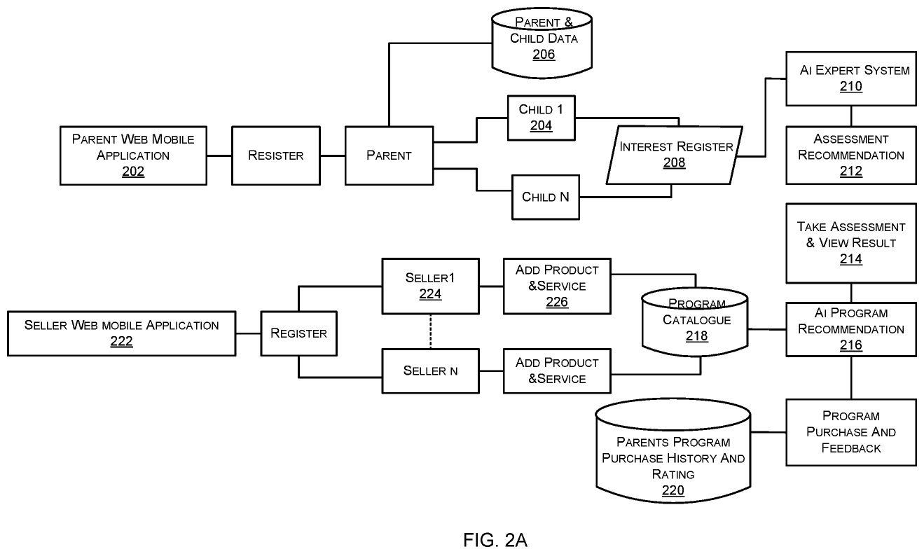

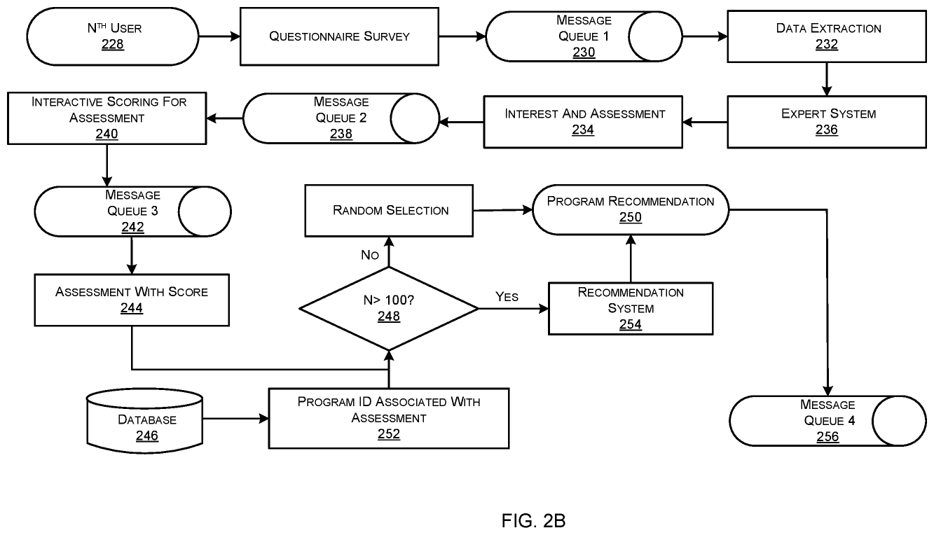

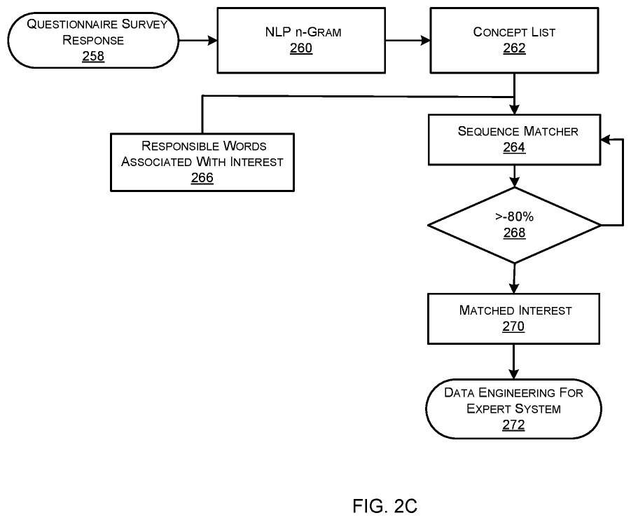

FIG. 2A illustrates a framework for the application in accordance with an embodiment of the present disclosure. The registration process is performed by parents via a mobile/web registration module 202. The parent can enrol multiple children's information if required 204. The parents and child data are stored on database 206 until the information is further processed. The child answers a set of questionnaires, which captures the interests 208 of the child and the details are passed on to the AI expert engine or system 210. The AI expert system 210 analyses the questionnaire input by the child and further provides assessment recommendations 212. The child can further take any recommended assessment and view the results 214. The AI program recommendation 216 uses the program catalogue 218 to make program recommendation suitable to nurture the interest of the child, based on factors such as assessment scores, parent and child attributes in the database 206 and previous user ratings of programs from parent's program purchase history and rating database 220.

In another embodiment, the sellers can register to the application via web/mobile application module 222 and multiple sellers from different categories/fields register, like seller-1, seller-n 224. Registered sellers can add products or services 226, which are subsequently added to the program catalogue 218, in which programs are mapped based on age group, skill, and category of skill score.

FIG. 2B illustrates an exemplary representation of the AI system flow framework in accordance with an embodiment of the present disclosure. Referring to FIG. 2B, the questionnaire survey response filled by the Nth user 228 is sent to a message queue 230, where the responses of the users are stored on the queue until they are processed. The interest associated with a question in the questionnaire is captured 232 to obtain the interests and assessments or skills 234 from the expert system or engine 236 and the same is sent to a different message queue 238. The interests and the corresponding assessments and scores obtained from queue 238 are used to conduct interactive feedback for the users. Based on the feedback response from the users the apt assessments and interactive scores for the respective interests 240 are decided and sent to the message queue 242. The assessment scores 244 for the user are utilised to evaluate the aptitude of the user and based on this category program IDs 252 corresponding to each assessment are retrieved from the database 246. The criteria 248 is applied to decide upon the method of program ID recommendation 250. If the integer N is greater than 100, the recommendation system or engine 254 uses the collaborative topic regression (CTR) model otherwise random selection is applied for the program recommendation 250. The recommended programs 250 are in turn sent to a message queue 256 and made available for the end-users.

FIG. 2C illustrates an exemplary flow chart of the feature engineering technique for expert systems in accordance with an embodiment of the present disclosure. Referring to FIG. 2C, to identify the interests associated with each question of the survey, a feature engineering technique using n-grams is implemented. At block 258, each question of the questionnaire survey is undergone with text pre-processing techniques and is applied with N-gram at block 260, which reflects information about the content along with the context. These n-gram sequences at block 262 of each question are matched at block 264 with the predefined keywords. At block 266 the predefined keywords associated with each of the interests generate a score indicating the closeness measure between the two sequences. At block 270, the interest associated with a question is thus identified by checking at block 268 if the score is greater than or equal to the defined threshold e.g., 80%. At block 272, the matched interest is considered as the input to the expert system for further analysis along with the rating given to it by the user.

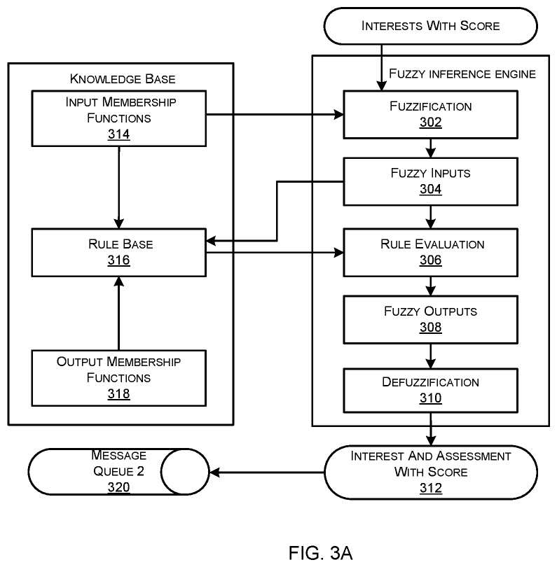

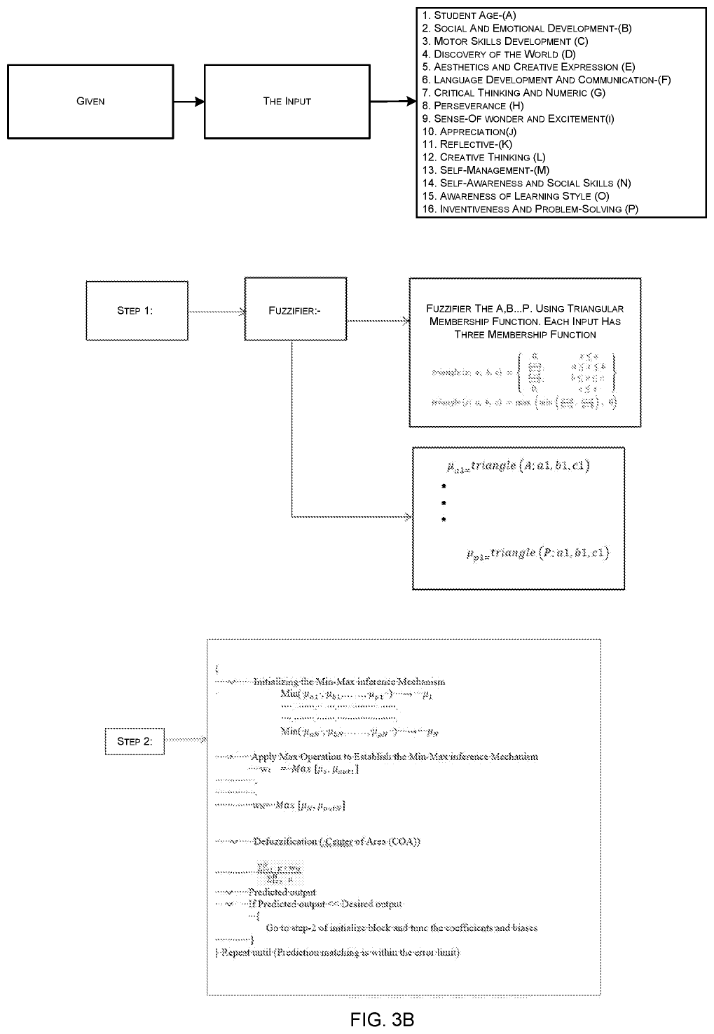

FIG. 3A illustrates an exemplary representation of the fuzzy expert system in accordance with an embodiment of the present disclosure. As depicted in FIG. 3A, the fuzzy expert system helps to reduce the uncertainty in obtaining the appropriate assessments with scores from the given input parameters of interests with the score along with other demographic information e.g., child's age, child's education, parent's education.

At block 302, in the fuzzification process, a membership function is applied for converting the input parameters to a fuzzy value i.e., probabilistic value, so as to handle the uncertainty in it at block 304. Mamdani fuzzy inference systems approach is applied in the fuzzification process to create a control system by synthesising a set of control rules obtained from the domain experts. At block 308, the fuzzification for the output is implemented similarly to obtain a fuzzy value.

At block 314, a relationship is built using the membership functions, which are defined for each input parameter based on the categories of the value. At block 306, after procuring the fuzzy values, inference rules using if-else and mean-maximum operators are applied in this fuzzy inference system. At block 316, the total number of rules defined is dependent on the number of membership functions of each input and output parameter. At block 318 is the output membership function. At block 310, after applying these rules, defuzzification, using the centroid method, is implemented to obtain the real values. Thus, in block 310, with respect to the input parameters, the fuzzy inference system is shown in FIG. 3B generates the assessment with more than 97% accuracy and with an appropriate score at block 312, which in turn is passed to a message queue at block 320 for further processing.

Interactive scoring for assessment: Based on the given top-rated interests and assessments from the expert system, the aptitude of a student is evaluated. The score obtained by the student in the evaluation process is used to define the category in which the student belongs (namely novice, developing and proficient). This helps to bring out the attention level required for the student and helps to identify the programs for assessments corresponding to the category the student belongs to. The programs to be recommended are later filtered from these sets of programs.

Program recommendation: For the initial ‘C’ (here 100) users due to insufficient data, a random selection approach using the Roulette wheel is implemented and as the user number exceeds the count ‘C’, the collaborative topic regression (CTR) approach is used for the program recommendation

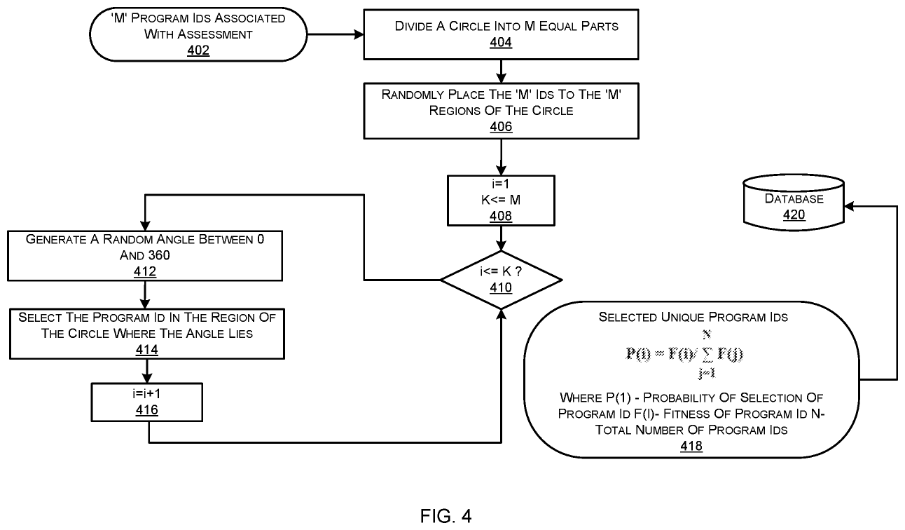

FIG. 4 illustrates an exemplary flow chart of program recommendations using random selection using the Roulette wheel in accordance with an embodiment of the present disclosure. At block 402, the functionality of the Roulette wheel is to randomly select a set of program IDs from all the program IDs associated with the assessments for a particular user lying in a category based on the aptitude score. At block 404, based on the number of program IDs associated with the assessments as the input to this system a circle is equally divided and at block 406, the IDs are randomly placed in each of the regions. At block 412, a random angle between 0 to 360 is generated and at block 414, a program ID corresponding to the region where the angel falls is selected. At block 410, this process of selection is repeated for the ‘K’ number of spins, which depends on the number of program IDs needed to suggest, for example, 40%. At block 408, the iteration process is iterated by initialization, incrementation at block 416 and condition check at block 410 to get a unique set of selected program IDs, which are used for recommendation at block 418. Once the relevant programs are purchased by the user, the same is updated in the database at 420 along with the ratings made by the user.

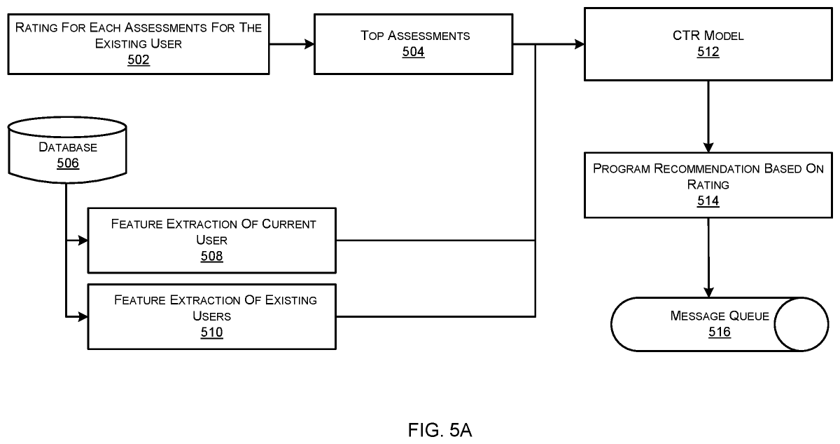

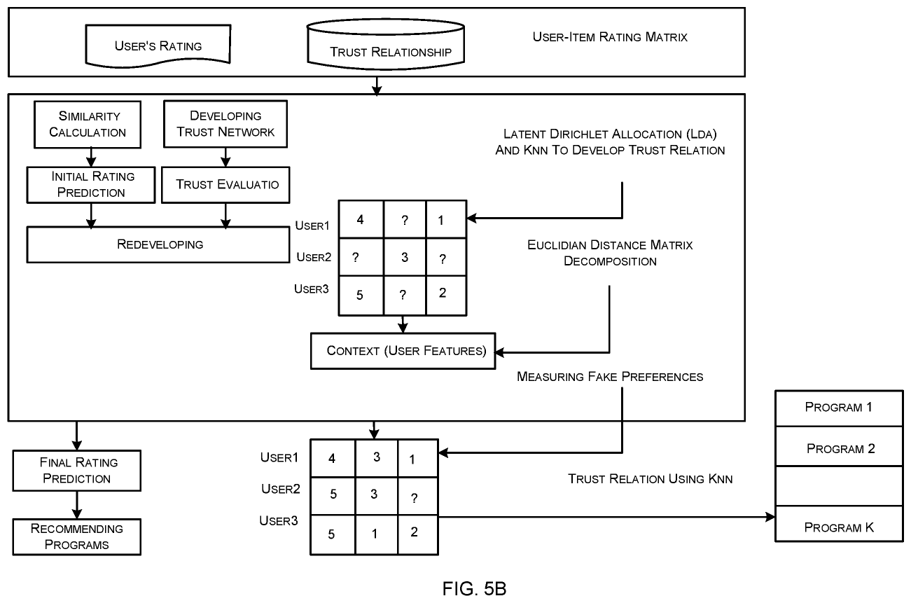

FIG. 5A illustrates an exemplary flow chart of representation of program recommendations using the collaborative topic regression (CTR) model in accordance with an embodiment of the present disclosure. As depicted in FIG. 5A, for getting better accuracy from the CTR model the user-product matrix must be updated with more users. For this reason, recommendations for the initial 100 users are made using a random selection approach and CTR approach for the users thereafter. The CTR model has two components, namely, Probabilistic Matrix Factorization (PMF) and Latent Dirichlet Allocation (LDA). Here the recommendation method considered is the latent factor model using matrix factorization. The traditional collaborative filtering approaches provide recommendations based on users with similar patterns of selected products. At block 512, in the CTR approach shown in FIG. 5B, the user features are also taken into consideration to provide appropriate recommendations for finding similar patterns of product selection made by user types using PMF. This approach can form recommendations for both existing and newly released products.

At block 502, the ratings of each assessment from the existing users are provided. At block 504, top assessments are extracted from the ratings of each assessment from the existing users. At block 508, in order to proceed to the next step, extract features of the current user and the existing users at block 510. The features considered for the method are age, assessment, occupation of the parent, education of the parent and assessment score, which are retrieved from the database at block 506. Topic modelling using LDA and K-Nearest neighbour (KNN) helps the model identify different user types based on the various user features. In block 514, after finding similar user types, the higher-rated programs of each closest trust user may be selected and recommended for the current user. It can give more than 97% accuracy and recommend the appropriate Program IDs. At block 516, the recommendation list of programs for the current user may be sent to the message queue.

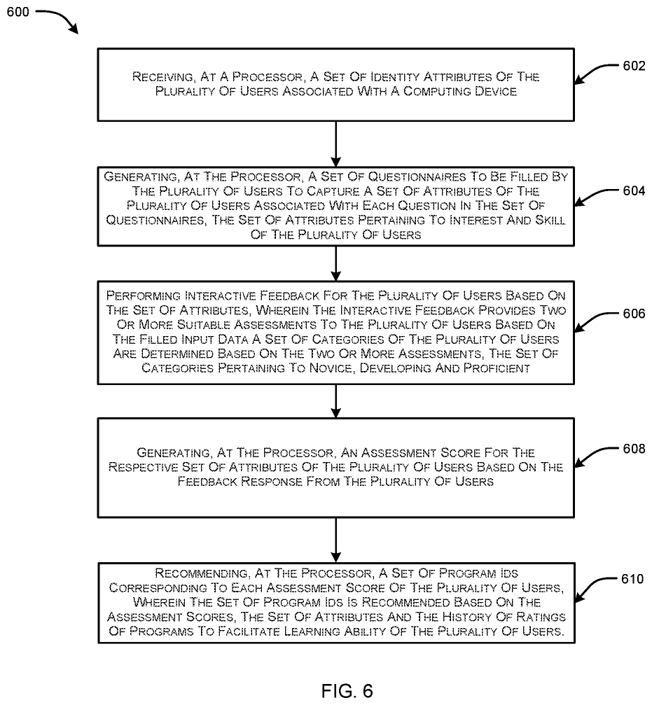

FIG. 6 illustrates an exemplary flow chart of a method for recommending program options to a plurality of users, in accordance with an embodiment of the present disclosure.

Referring to FIG. 6, method 600 includes block 602, the processor can receive the set of identity attributes of the plurality of users associated with the computing device. At block 604, the processor can generate a set of questionnaires to be filled by the plurality of users to capture the set of attributes of the plurality of users associated with each question in the set of questionnaires. The set of attributes pertaining to the interest and skill of the plurality of users.

At block 606, the processor can perform interactive feedback for the plurality of users based on the set of attributes. The two or more suitable assessments is provided to the plurality of users based on the filled input data, a set of categories of the plurality of users are determined based on the two or more assessments, the set of categories pertaining to novice, developing and proficient.

At block 608, the processor can generate an assessment score for the respective set of attributes of the plurality of users based on the feedback response from the plurality of users. At block 610, the processor can recommend the set of program IDs corresponding to each assessment score of the plurality of users. The set of program IDs is recommended based on the assessment scores, the set of attributes and the history of ratings of programs to facilitate the learning ability of the plurality of users.

It will be apparent to those skilled in the art that the system 102 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Invention

The present disclosure provides a system that identifies interest areas of students and recommends the best programs to the students based on their interests and assessment results.

The present disclosure provides a system that provides collaborative topic regression (CTR) approach to recommendation systems by recommending items to a user not only based on an in-matrix prediction but also out-of-matrix prediction.

The present disclosure provides a system that distinguishes the user features for explaining recommendations from features important for explaining user behaviour.

The present disclosure provides a system using a CTR model that may recommend the appropriate program IDs giving an accuracy of 95-97% by analysing the new user's features and previous user's features.

The present disclosure provides a system with a CTR model that is very robust in recommending the appropriate programs for the user, the CTR model has the capabilities to build the trusted user by taking the social matrix factorization.

The present disclosure provides a system that handles uncertainty by using an expert system and easily mapping questions to assessments with high accuracy.

The present disclosure provides a system that helps to transfer human intelligence to machine intelligence, thereby producing results in a very appropriate way.

The present disclosure provides a system that appropriately converts qualitative input data such as questionnaires, age, demographic data, and social data to quantitative output data assessment along with a probability score.

The present disclosure provides a system that takes lower computational cost i.e., less than 3 seconds.

We claim:

1. A system (100) for recommending program options to a plurality of users (108), the system comprising:
a processor (112) operatively coupled to a memory (114), the memory storing instructions executable by the processor to:
receive a set of identity attributes of a plurality of users (108) associated with a computing device (106);
generate a set of questionnaires to be filled by the plurality of users (108) to capture a set of attributes associated with each question in the set of questionnaires, the set of attributes pertaining to interest and skill of the plurality of users;
perform interactive feedback for the plurality of users (108) based on the set of attributes, wherein two or more suitable assessments are provided to the plurality of users based on the filled input data, a set of categories of the plurality of users are determined based on the two or more suitable assessments, the set of categories pertaining to novice, developing and proficient;
generate an assessment score for the respective set of attributes of the plurality of users (108) based on the feedback response from the plurality of users; and
recommend a set of program IDs corresponding to each assessment score of the plurality of users (108), the set of program IDs is recommended based on the assessment scores, the set of attributes and the history of ratings of the programs to facilitate the learning ability of the plurality of users.

2. The system as claimed in claim 1, wherein the set of attributes associated with the set of questionnaires is identified by setting a score that is greater than or equal to a defined threshold.

3. The system as claimed in claim 1, wherein the processor (112) is operatively coupled to a learning engine (118) that comprises an expert engine (124) and a recommendation engine (126), the learning engine (118) adapted to capture the set of attributes associated with the set of questionnaires of the plurality of the users (108) to generate corresponding assessment scores, wherein the learning engine (118) is artificial intelligence (AI).

4. The system as claimed in claim 1, wherein the learning engine (118) is trained to recommend the set of program IDs corresponding to each assessment score of the plurality of users (108) to nurture the interest of the plurality of users.

5. The system as claimed in claim 3, wherein the expert engine (124) minimizes the uncertainty in obtaining the appropriate assessment scores by using the set of attributes along with the set of identity attributes of the plurality of users (108).

6. The system as claimed in claim 1, wherein the set of identity attributes pertains to the age of the plurality of users, occupation of a parent, education of parent and any combination thereof, wherein the users are students.

7. The system as claimed in claim 3, wherein the recommendation engine (126) recommends the set of program IDs corresponding to each assessment score, the assessment scores for the plurality of users are utilised to evaluate the aptitude of each user.

8. The system as claimed in claim 7, wherein the recommendation of the set of program IDs is determined based on the criteria value to select any or a combination of collaborative topic regression (CTR) mode or random selection mode.

9. The system as claimed in claim 1, wherein the processor (112) adds products or services by a seller, in which programs are mapped based on age group, skill, and category of skill score.

10. A method (600) for recommending program options to a plurality of users, the method comprising:
receiving (602), at a processor, a set of identity attributes of the plurality of users associated with a computing device;
generating (604), at the processor, a set of questionnaires to be filled by the plurality of users to capture a set of attributes of the plurality of users associated with each question in the set of questionnaires, the set of attributes pertaining to interest and skill of the plurality of users;
performing (606), at the processor, interactive feedback for the plurality of users based on the set of attributes, wherein two or more suitable assessments is provided to the plurality of users based on the filled input data, a set of categories of the plurality of users are determined based on the two or more suitable assessments, the set of categories pertaining to novice, developing and proficient;
generating (608), at the processor, an assessment score for the respective set of attributes of the plurality of users based on the feedback response from the plurality of users; and
recommending (610), at the processor, a set of program IDs corresponding to each assessment score of the plurality of users, wherein the set of program IDs is recommended based on the assessment scores, the set of attributes and the history of ratings of programs to facilitate learning ability of the plurality of users.
